(19) United States
(12) Patent Application Publication
(10) Pub. No.: US 2005/0129803 A1
(43) Pub. Date: Jun. 16, 2005

(54) Injection nozzle, blast processing device and blast processing method with the injection nozzle, method of forming lubricating layer by the blast processing method, and sliding product with the lubricating layer formed by the method

(75) Inventors: Kazunori Umeda, Ibaraki (JP); Masato Ishiwata, Tokyo (JP); Morio Tsukita, Tokyo (JP); Mikio Tsukamoto, Tokyo (JP); Akihiro Tanaka, Ibaraki (JP); Kotaro Hanada, Ibaraki (JP)

Correspondence Address: DONN K. HARMS;PATENT & TRADEMARK LAW CENTER, SUITE 100, 12702 VIA CORTINA, DEL MAR, CA, 92014, US

(73) Assignee: FUJI MANUFACTURING CO., LTD.

(21) Appl. No.: 10/984,583

(22) Filed: Nov. 8, 2004

(30) Foreign Application Priority Data
Nov. 11, 2003 (JP) 2003-381844

(51) Int. Cl. B29C 45/00

(52) U.S. Cl. 425/568

(57) ABSTRACT

A method enabling to form a lubricating layer on a work piece and a device to form the same in a simple blast processing are provided, in which injection materials can be injected at higher speed than the conventional way, thereby even a small specific gravity injection materials such as graphite and the like can be used for blast operation.
In an injection nozzle of a direct pressure type blast processing device which injects a mixture of injection materials and compressed gas, an aperture which is formed in an axial direction of the injection nozzle has such shape that meets the following conditional equations (1) and (2) in a cross section orthogonal to the axial direction at an arbitrary distance x away from the entrance of the injection nozzle.

$$\begin{matrix}a = {\frac{G}{{p}_{1}} [ \frac{2 g κ}{κ - 1} \frac{1}{{RT}_{1}} \{ {( \frac{p}{{p}_{1}} )}^{\frac{2}{κ}} - {( \frac{p}{{p}_{1}} )}^{\frac{κ + 1}{κ}} \} ]}^{- \frac{1}{2}} & ( 1 ) \\ \frac{p}{{p}_{1}} = 1 - ( 1 - \frac{{p}_{2}}{{p}_{1}} ) ( \frac{x}{L} ) & ( 2 )\end{matrix}$$

### BACKGROUND OF THE INVENTION

1. Field of the Invention

The present invention relates to an injection nozzle and a blast processing method which are suitable for injecting injection materials on a work piece at a high speed, a blast processing device with the injection nozzle, and a method of forming a lubricating layer on the surface of the work piece by the blast processing method.

2. Description of the Related Art

Generally, a lubricating layer is formed on the surface of machine element components such as sliding products and the like which require frictional resistance and abrasion resistance so that a superior frictional resistance and an abrasion resistance can be provided over a prolonged period. As a method of forming such a lubricating layer, there is a method of applying liquid lubricants such as lubrication oil, grease or the like, on the surface. The effect of this method, however, is restricted by the working environment in such a way that the lubricating effects can hardly be performed under the conditions of vacuum, ultrahigh/extremely low temperatures or the like. Therefore, instead of the above-mentioned liquid lubricants, such methods are generally used for forming the lubricating layer as using solid lubricants such as graphite, molybdenum disulfide (MOS₂), tungsten disulfide (WS₂), polytetrafluoroethylene (PTFE) and boron nitride, or a high-polymer material like fluorocarbon resin.

As methods of forming a lubricating layer using the above-described solid lubricants, there are, a method of coating and drying a solid lubricant together with a binder on a surface of a work piece, a method which first roughens a surface of a work piece, then disposes a solid lubricant on the surface, and thereafter, performs a baking process, and a method such as an ion plating method or a sputtering method which diffuses a solid lubricant on a surface of a work piece by use of the vacuum evaporation technology. Besides, there are also mechanical methods, which, for instance, are as follows;
Lubricant particles made of either of molybdenum disulfide or graphite, or the both of them, mixed together with steel balls having hardness equivalent to or more than that of a dish-type spring are injected on the surface of the dish-type springs, thus the lubricant particles are repeatedly shot on the surface while forming concavities and convexities like peer-skin surface due to impact energy generated by the collisions of the steel balls, thereby a lubricating layer based on either molybdenum disulfide or graphite, or both of them is formed (refer to 11-315868), and,
in a method disclosed in 08-196951, rolling objects of roller bearings, together with solid lubricants in a scale-like or micro powder form, such as graphite, PTFE (polytetrafluoroethylene) or the like, are put into a ball mill container, and the container is then rotated. Consequently, the surfaces of these rolling objects are coated with the solid lubricants by impact energy and friction energy generated by collisions of the rolling objects with each other.

Moreover, in a method disclosed in Ogiwara, a coated layer made of molybdenum disulfide is formed on a work piece by injecting molybdenum disulfide powders onto the surface of the work piece.

The documents describing the above related arts are as follows.
Japanese Unexamined Patent Publication No.11-315868
Japanese Unexamined Patent Publication No.08-196951

Surface Reformation of Sliding Portion of a Piston for an Internal Combustion Engine by Peening Process by use of Fine Particles of Solid Lubricants, Tribologist, Vol. 47, Num. 12, 2002, P895, Hidemi Ogiwara (herein referred to Ogiwara).

According to the methods described in the above mentioned Patent 11-315868 and 08-196951, it becomes relatively easier to form a lubricating layer without restriction of material properties of a work piece and also without need of pretreatment by such as phosphate the work piece like a method of coating and drying a solid lubricant together with a binder, or without using an expensive apparatus in a chemical method such as vacuum evaporation.

However, in the method described in 11-315868, shooting solid lubricants to a dish-type spring as a work piece requires steel balls having hardness equivalent to or more than that of the work piece, and therefore, a lubricating layer can not be formed only by use of solid lubricants. Furthermore, in the method described in 08-19695, although a lubricating layer can be formed by only solid lubricants and a rolling object as a work piece, it is necessary to put the work pieces together with solid lubricant into a ball mill container to rotate, resulting a problem that shapes and sizes of potential work pieces are extremely limited.

In contrast, the method described in Ogiwara has advantages that the method can form a lubricating layer with a simple method of injecting only molybdenum disulfide as a solid lubricant on a work piece and also can provide work pieces with various shapes and sizes availability.

Therefore, it is preferable to extend the application of forming a lubricating layer by injecting graphite which is less expensive than the molybdenum disulfide, yet has the same performance thereof, and enabling steel and the like to be a work piece, which has a higher hardness and a higher melting point than an aluminum alloy.

However, in the method described in Ogiwara, since the solid lubricants are penetrated into the work piece only by collision energy of the injected solid lubricants on the work piece surface, the energy needs to be quite huge. As a result, the solid lubricant used as an injection material is limited to molybdenum disulfide having a high specific gravity and also a material of the work piece is limited to aluminum alloy with low hardness.

Namely, the specific gravity of graphite is 2.24, which is less than ½ of 4.8 with molybdenum disulfide, and the collision energy generated becomes smaller proportionally. Consequently, even if the graphite is injected under the same conditions as the molybdenum disulfide injection, the graphite penetrates poorly into the work piece, causing problems of lifecycle or strength and the like in terms of a lubricating layer formed by the injection of the graphite, therefore, this method can not be put into practical use.

Reduction of collision energy generated due to the difference in the gravity causes a more serious problem in the case of using, as a work piece, steel or the like which has a high hardness or a high melting point.

Then, in case of adopting graphite with small specific gravity as the injection materials, considering that not only the specific gravity but also the injection speed relates significantly to the collision energy, it is conceivable that the injection speed of injection materials is increased to be higher than the conventional way. A conventional blast processing device, however, has a limitation in increasing the injection speed of injection materials, and then the lubricating layer forming by injecting graphite has not been able to put into practical use.

Based upon the foregoing problems, the present invention clarifies an arrangement in which an injection material can be injected at higher speeds than conventional way, whereby the present invention has an object of providing a method and an apparatus which can form a lubricating layer on a work piece with a simple method called a blast processing by use of a solid lubricant having a small specific gravity such as graphite.

In the above explanation, the related art is explained based upon the injection of the solid lubricant such as graphite or like, but an injection nozzle, a blast processing device and a blast processing method of the present invention are not limited to the injection material such as the solid graphite and can be applied to various injection materials.

According to the present invention, various injection materials can be injected at higher speed as compared to the conventional way, by forming a shape of an injection nozzle (path) through which injection materials pass in blast processing, to be a specific shape to meet a predetermined condition.

Therefore, an injection nozzle and a blast processing method of the present invention can be preferably applied to various blast processes in which high speed injection is demanded and thereby, desired effects can be obtained in various processing such as coating formation, grinding, cutting, shot peening, peer-skin pattern formation and the like.

Especially in coated layer formation process of conventional way, it was not possible to form a coated layer unless using injection materials having relatively large specific gravity in view of the collision energy generated in collisions of the injection materials to the surface of work pieces. In contrast, an injection nozzle and a blast processing devise of the present invention can increase injection speeds of injection materials to obtain large collision energy even in using small specific gravity injection materials, thereby it becomes possible to provide coated layer formation by small specific gravity injection materials.

In consequence, even the use of graphite as injection materials, having a smaller specific gravity as compared to the molybdenum disulfide, a lubricating layer can be preferably formed, that is, with a simple method of graphite powder injection to the work piece surface, a lubricating layer made of graphite can be formed without using a binder.

Because of low friction coefficient and excellent lubricating property of graphite, which is equivalent to molybdenum disulfide in terms of performance, a preferable lubricating layer can be formed, and in addition to that, as the price is about ⅕ to 1/10 of that of the molybdenum disulfide, cost reduction can be realized as well.

Moreover, as a result of the collision energy increase due to improved injection speed, not only an aluminum alloy but also steel or the like can be used as a work piece, which can provide a wide application of products on which a lubricating layer is formed.

Since a lubricating layer formed by the present invention is strongly adhered to a work piece as a base material, a superior lubrication effect without separation and the like can be maintained for a long period of time. Such strong adherence is considered to be generated by physical penetration of lubricant components into the inside of work piece when the injected lubricants collide to the surface of work pieces.

And blast processing device manufacturing of the present invention can be achieved by replacing a conventional injection nozzle with an injection nozzle of the present invention, which does not need any big modification of the existing device arrangement and is quite practical.

### SUMMARY OF THE INVENTION

In order to solve the above problem, the present invention concerns an injection nozzle for a direct pressure type blast processing device which injects a mixture of an injection material and compressed gas, wherein an aperture formed in an axial direction of said injection nozzle meets the following conditional equations (1) and (2) at a cross section orthogonal to the axial direction at an arbitrary distance x away from an entrance of the injection nozzle,

$$\begin{matrix}a = {\frac{G}{{p}_{1}} [ \frac{2 g κ}{κ - 1} \frac{1}{{RT}_{1}} \{ {( \frac{p}{{p}_{1}} )}^{\frac{2}{κ}} - {( \frac{p}{{p}_{1}} )}^{\frac{κ + 1}{κ}} \} ]}^{- \frac{1}{2}} & ( 1 ) \\ \frac{p}{{p}_{1}} = 1 - ( 1 - \frac{{p}_{2}}{{p}_{1}} ) ( \frac{x}{L} ) , & ( 2 )\end{matrix}$$

wherein
a: cross section area orthogonal to the axial direction at an arbitrary distance x away from the entrance of the injection nozzle
G: weight flow amount of gas
g: acceleration of gravity
.: specific heat ratio of gas
R: gas constant
T₁: temperature of gas at the entrance of the injection nozzle
p: pressure of gas at an arbitrary distance x away from the entrance of the injection nozzle
p₁: pressure of gas at the entrance of the injection nozzle
p₂: pressure of gas at the exit of the injection nozzle
L: length of the injection nozzle

### BRIEF DESCRIPTION OF THE DRAWINGS

The object and advantages of the invention will become understood from the following detailed description of preferred embodiments thereof in connection with the accompanying drawings in which like names designate like elements, and in which:

FIG. 1 is a graph showing the relation between distances from an entrance of an injection nozzle according to the present invention and an inner diameter thereof.

FIG. 2 is a view showing a result of a GDS analysis (second embodiment).

FIG. 3 is a view showing the result of a GDS analysis (second comparative example).

FIG. 4 is a view showing images of SEM, C character X-ray and Fe character X-ray as a result of a SEM-EDX analysis (top surface).

FIG. 5 is a view showing images of SEM, C character X-ray and Fe character X-ray as a result of a SEM-EDX analysis (the depth of 2 μm from the top surface).

FIG. 6 is a TEM observation picture (SUJ2).

FIG. 7 is a TEM observation picture (A7075).

FIG. 8 is a TEM observation picture (SKD11).

FIG. 9A is a view showing a TEM-EDX analysis result (SUJ2: graphite layer).

FIG. 9B is a view showing a TEM-EDX analysis result (SUJ2: reaction layer).

FIG. 9C is a view showing a TEM-EDX analysis result (SUJ2: base material part).

FIG. 10A is a view showing a TEM-EDX analysis result (A7075: graphite layer).

FIG. 10B is a view showing a TEM-EDX analysis result (A7075: reaction layer).

FIG. 10C is a view showing a TEM-EDX analysis result (A7075: base material part).

FIG. 11 is a view showing a qualitative analysis result of the top surface of a FE-AES analysis.

FIG. 12 is a view showing a depth direction analysis result of a FE-AES analysis.

FIG. 13 is a view showing a result of a friction experiment (third embodiment). (A) is a view showing frictional behaviors, (B) and (C) are pictures of friction marks by an optical microscope, and (D) shows a curve of roughness of a disk friction mark.

FIG. 14 is a view showing a result of a friction experiment (third comparative example). (A) is a view showing friction behaviors, (B) and (C) are pictures of friction marks by an optical microscope, and (D) shows a curve of the roughness of a disk friction mark.

FIG. 15 is a view showing a result of a friction experiment (forth embodiment). (A) is a view showing friction behaviors, (B) and (C) are pictures of friction marks by an optical microscope, and (D) shows a curve of roughness of a disk frictional mark.

FIG. 16 is a view showing a result of a friction experiment (forth comparative example). (A) is a view showing friction behaviors, (B) and (C) are pictures of friction marks by an optical microscope, and (D) shows a curve of roughness of a disk friction mark.

FIG. 17 shows surface pictures of a molded product of a fifth embodiment and a fifth comparative example.

FIG. 18 is a view showing the measurement results of surface roughness in an axis direction (L) and in a circumferential direction (.).

FIG. 19 is a perspective view showing a method for a friction experiment.

### DETAILED DESCRIPTION OF THE PREFERRED EMBODIMENT

Embodiments of the present invention will be explained as follows.

1. Injection Nozzle

In the present embodiment, a path in which the injection materials and the compressed gas pass through for an improvement of the injection speed is realized by way of an injection nozzle to use in a blast processing device.

The injection nozzle of the present invention is distinctive in shape as shown below.

Conditional Equation for Determining the Shape of the Injection Nozzle

In the injection nozzle of the present invention, an aperture formed in the axis direction of the injection nozzle has a cross sectional area am² to meet the following conditional equations (1) and (2) in the cross section orthogonal to an axial direction of the injection nozzle in an arbitrary distance x m away from the entrance of the injection nozzle.

Further, p in the following conditional equation (1) is set to meet the conditional equation (2).

$$\begin{matrix}a = {\frac{G}{{p}_{1}} [ \frac{2 g κ}{κ - 1} \frac{1}{{RT}_{1}} \{ {( \frac{p}{{p}_{1}} )}^{\frac{2}{κ}} - {( \frac{p}{{p}_{1}} )}^{\frac{κ + 1}{κ}} \} ]}^{- \frac{1}{2}} & ( 1 ) \\ \frac{p}{{p}_{1}} = 1 - ( 1 - \frac{{p}_{2}}{{p}_{1}} ) ( \frac{x}{L} ) & ( 2 )\end{matrix}$$

Herein, the above signs represent the following. In addition, when a sign has a subscript, the subscript 1 indicates a value at the entrance of the injection nozzle and subscript 2 indicates a value at the exit of the injection nozzle. And, when a sign has no subscript, that indicates a value in any location x.
g: acceleration of gravity g=9.8 [m/sec²]
.: specific heat ratio of gas [(cₚ/cᵥ)]
R: gas constant [kJ/(kg·K)]
T₁: temperature of gas at the entrance of the injection nozzle [K]
p: pressure of gas at an arbitrary distance x away from the entrance of the injection nozzle [Pa]
p₁: pressure of gas at the entrance of the injection nozzle [Pa]
p₂: pressure of gas at the exit of the injection nozzle [Pa]
G: weight flow amount of gas [N/sec]
x: any position away from the entrance of the injection nozzle [m]
L: length of the nozzle [m]

Furthermore, for example, the temperature T1 of gas at the entrance of the injection nozzle can be set from 223 to 573 K, and, the pressure p₁ of gas at the entrance of the injection nozzle can be set approximately from 0.01 to 5 MPa.

Production of the Conditional Equations

The above described equation (1) which determines the shape of the injection nozzle is extracted as follows.

It is noted that in the case of extracting the equation (1), the gas as an object is set to be a perfect gas of one dimensional steady flow and the above described signs represent the same meanings in the following. The newly used signs are shown as follows.
v: specific volume of gas [m³/N]
.: density of gas [kg/m³]
i: enthalpy of gas [kcal]
J: equal amount work of heat

In order to convert the enthalpy [kcal] of i to [J], J=4185.5 (J/kcal) is used.

Energy (Energy Conservation) Equation

When having a gas unit mass of 1 kg, and Q [kcal/kg] represents the heat amount given from an outside, Ws [J/kg] represents the work to an outside, and Wf [J/kg] represents the friction work, assuming that all the friction work Wf is dissipated to be used for heating fluid, and the potential energy is ignored, the energy conservation equation becomes the equation (3) shown as follows, whereby the following equation (4) is extracted. The equation (5) shows a differential form of the equation (4).

$$\begin{matrix}JQ + {W}_{f} = J ( {i}_{2} - {i}_{1} ) + ( \frac{{w}_{2}^{2}}{2 g} - \frac{{w}_{1}^{2}}{2 g} ) + {W}_{f} + {W}_{s} & ( 3 ) \\ JQ - {W}_{s} = J ( {i}_{2} - {i}_{1} ) + ( \frac{{w}_{2}^{2}}{2 g} - \frac{{w}_{1}^{2}}{2 g} ) & ( 4 ) \\ J δ Q - δ {W}_{s} = Jdi + \frac{1}{g} wdw & ( 5 )\end{matrix}$$

Momentum Equation (Momentum Formula)

When considering the equilibrium of forces in the flow direction with regard to the fluid segment with an extremely short length dx in the flow direction, the equation (6) is extracted. The equation (7) is a simplified form of equation (6) by rearranging the both side thereof.

$$\begin{matrix}ρ • Fa • Fdx • Fw \frac{ⅆ w}{ⅆ x} = - a • Fdp - ρ • Fg • Fa • Fdx • E \frac{δ {W}_{f}}{dx} - & ( 6 ) \\ ρ • Fg • Fa • Fdx • E \frac{δ {W}_{s}}{dx} & \\ vdp + \frac{1}{g} wdw + δ {W}_{f} + δ {W}_{s} = 0 & ( 7 )\end{matrix}$$

Isentropic Flow

In an adiabatic frictionless flow assuming no transfer of heat and work (Q=0, Wₛ=0), nor friction (W_{f}=0), the flow becomes an isentropic flow having a constant entropy, thus the above described equations (5) and (7) become to be as the equations (8), (9) below.

From the equations (8) and (9) below, the equation (10) is extracted, and the equation (11) is further obtained from the equation (10). It is noted that a subscription s stands for an isentropic flow.

$$\begin{matrix}Jdi + \frac{1}{g} wdw = 0 & ( 8 ) \\ vdp + \frac{1}{g} wdw = 0 & ( 9 ) \\ \frac{1}{g} wdw = - vdp = - Jdi & ( 10 ) \\ vdp = Jdi & \\ \frac{{w}_{2 s}^{2}}{2 g} - \frac{{w}_{1}^{2}}{2 g} = J ( {i}_{1} - {i}_{2 s} ) & ( 11 )\end{matrix}$$

The above equation (11) can be rearranged as the equation (12), and enthalpy i is represented as i=c_{pT} using specific heat constant cₚ in case of perfect gas, therefore, the equation (12) can be described as the following equation (13).

$$\begin{matrix}{w}_{2 s} = \sqrt{2 gJ ( {i}_{1} - {i}_{2} ) + {w}_{1}^{2}} & ( 12 ) \\ {w}_{2 s} = \sqrt{2 {gJc}_{p} ( {T}_{1} - {T}_{2 s} ) + {w}_{1}^{2}} = \sqrt{2 {gJc}_{p} {T}_{1} ( 1 - \frac{{T}_{2 s}}{{T}_{1}} ) + {w}_{1}^{2}} & ( 13 )\end{matrix}$$

Herein, on the assumption of perfect gas, the specific heat of gas cₚ in the state of an isobaric change is given by the equation (14) shown below.

Moreover, in an isentropic flow with adiabatic state, the equations (15) and (16) can be obtained as follows, thereby the equation (17) is extracted, and the equation (13) becomes the equation (18).

$$\begin{matrix}{c}_{p} = \frac{κ R}{κ - 1} & ( 14 ) \\ pv = RT {p}_{1} {v}_{1} = {RT}_{1} {p}_{2 s} {v}_{2 s} = {RT}_{2 s} {w}_{2 s} & ( 15 ) \\ \frac{{p}_{1} {v}_{1}}{{T}_{1}} = \frac{{p}_{2 s} {v}_{2 s}}{{T}_{2 s}} ( \frac{{v}_{1}}{{v}_{2 s}} ) = \frac{{p}_{2 s}}{{p}_{1}} \frac{{T}_{1}}{{T}_{2 s}} & \\ {pv}^{κ} = const {p}_{1} {v}_{1}^{κ} = {p}_{2 s} {v}_{2 s}^{κ} ( \frac{{v}_{1}}{{v}_{2 s}} ) = {( \frac{{p}_{2 s}}{{p}_{1}} )}^{\frac{1}{κ}} & ( 16 ) \\ {( \frac{{p}_{2 s}}{{p}_{1}} )}^{\frac{1}{κ}} = \frac{{p}_{2 s}}{{p}_{1}} \frac{{T}_{1}}{{T}_{2 s}} \frac{{T}_{2 s}}{{T}_{1}} = {( \frac{{p}_{2 s}}{{p}_{1}} )}^{\frac{κ - 1}{κ}} & ( 17 ) \\ {w}_{2 s} = \sqrt{\begin{matrix}\frac{2 g κ}{κ - 1} {RT}_{1} [ 1 - \\ {( \frac{{p}_{2 s}}{{p}_{1}} )}^{\frac{κ - 1}{κ}} ] + {w}_{1}^{2}\end{matrix}} = \sqrt{\begin{matrix}\frac{2 g κ}{κ - 1} {p}_{1} {v}_{1} [ 1 - \\ {( \frac{{p}_{2 s}}{{p}_{1}} )}^{\frac{κ - 1}{κ}} ] + {w}_{1}^{2}\end{matrix}} & ( 18 )\end{matrix}$$

Herein, by replacing the equation (18) by using the equation (19) shown below, the equation (18) can be arranged as the equation (20).

$$\begin{matrix}α = \frac{κ - 1}{κ} \frac{{w}_{1}^{2}}{2 {gp}_{1} {v}_{1}} = \frac{κ - 1}{κ} \frac{{w}_{1}^{2}}{2 {gRT}_{1}} & ( 19 ) \\ {w}_{2 s} = \sqrt{\begin{matrix}\frac{2 g κ}{κ - 1} {RT}_{1} [ ( 1 + α ) - \\ {( \frac{{p}_{2 s}}{{p}_{1}} )}^{\frac{κ - 1}{κ}} ]\end{matrix}} = \sqrt{\begin{matrix}\frac{2 g κ}{κ - 1} {p}_{1} {v}_{1} [ ( 1 + α ) - \\ {( \frac{{p}_{2 s}}{{p}_{1}} )}^{\frac{κ - 1}{κ}} ]\end{matrix}} & ( 20 )\end{matrix}$$

Herein, in a constant flow, since a flow amount G of gas passing through an arbitrary section is constant, the following equation (21) is established, and according to the equation (21), the following equation (22) from the above described equation (16), and the above equation (20), the flow amount G of gas is given in the following equation (23).

$$\begin{matrix}G = \frac{aw}{v} = \frac{{a}_{1} {w}_{1}}{{v}_{1}} = \frac{{a}_{2} {w}_{2}}{{v}_{2}} = aw ρ g & ( 21 ) \\ {v}_{2 s} = {{v}_{1} ( \frac{{p}_{1}}{{p}_{2 s}} )}^{\frac{1}{κ}} & ( 22 ) \\ G = \frac{{a}_{2} {w}_{2 s}}{{v}_{2 s}} = {a}_{2} \sqrt{\frac{2 g κ}{κ - 1} \frac{{p}_{1}}{{v}_{1}} [ ( 1 + α ) {( \frac{{p}_{2 s}}{{p}_{1}} )}^{\frac{2}{κ}} - {( \frac{{p}_{2 s}}{{p}_{1}} )}^{\frac{κ + 1}{κ}} ]} & ( 23 )\end{matrix}$$

When a pressure in any position is represented as p, and a cross section area of the injection nozzle as a, the following equation (24) can be obtained according to the above described equation (23). In the equation (24), when ignoring the gas flow rate at the entrance of the injection nozzle, w₁=0, namely α=0 is in the case and therefore, the above described conditional equation (1) can be derived.

$$\begin{matrix}a = \frac{G}{{p}_{1}} \frac{1}{\sqrt{\frac{2 g κ}{κ - 1} \frac{1}{R {T}_{1}} [ ( 1 + α ) {( \frac{p}{{p}_{1}} )}^{\frac{2}{κ}} - {( \frac{p}{{p}_{1}} )}^{\frac{κ + 1}{κ}} ]}} & ( 24 ) \\ \begin{matrix}a = \frac{G}{{p}_{1}} \frac{1}{\sqrt{\frac{2 g κ}{κ - 1} \frac{1}{R {T}_{1}} [ {( \frac{p}{{p}_{1}} )}^{\frac{2}{κ}} - {( \frac{p}{{p}_{1}} )}^{\frac{κ + 1}{κ}} ]}} \\ = {\frac{G}{{p}_{1}} [ \frac{2 g κ}{κ - 1} \frac{1}{R {T}_{1}} \{ {( \frac{p}{{p}_{1}} )}^{\frac{2}{κ}} - {( \frac{p}{{p}_{1}} )}^{\frac{κ + 1}{κ}} \} ]}^{- \frac{1}{2}}\end{matrix} & ( 1 )\end{matrix}$$

The equation (1) shows that a section area a of an aperture which is located at an arbitrary position with distance x away from the injection nozzle entrance can be obtained, if the gas flow amount G flowing in the injection nozzle, the temperature T₁ and gas pressure p₁ at the entrance, and the gas pressure p at the arbitrary position are determined.

Further, the equation (2) which expresses the condition to be met for obtaining the section area a of the injection nozzle of the present invention from the equation (1), is a related equation under a constant pressure gradient which is obtained by assuming that the gas pressure p at an arbitrary position with distance x away from the injection nozzle entrance is proportionally decreased towards the exit (atmospheric pressure).

$$\frac{p}{{p}_{1}} = 1 - ( 1 - \frac{{p}_{2}}{{p}_{1}} ) ( \frac{x}{L} ) \qquad ( 2 )$$

Setting of Numerical Value and Shape of Injection Nozzle

According to the above described conditional equation (1), in order to obtain the section area a of an aperture which is located at an arbitrary position with distance x away from the injection nozzle entrance, constants such as acceleration of gravity g, specific heat ratio of gas, gas constant R and further, gas flow amount G flowing in the injection nozzle, gas temperature T₁ and gas pressure p₁ in the injection nozzle entrance and gas pressure p at the arbitrary position are needed.

Therefore, in calculating a gas flow amount G, an inner diameter d as a portion of an aperture of the injection nozzle having a minimum inner diameter (referred to as a “throat” hereinafter) is set, and pressure, temperature and flow rate in the throat are obtained, and then, the gas flow amount G can be obtained according to the pressure, the temperature, the flow rate in the throat and the cross section area of the throat calculated by the above throat inner diameter d. Each value in the throat is represented by the following signs.
d: inner diameter of the throat [m]
aₜ: section area of the throat [m²]
Tₜ: gas temperature at the throat [K]
pₜ: gas pressure at the throat [kgf/cm²]
wₜ: gas flow rate at the throat [kgf/cm²]

It is noted that the inner diameter d with regard to the length L of the injection nozzle can be set to meet L/d=3 to 50.

Herein, in a constant flow, as described above, the gas weight flow amount G in any section will be constant, and therefore, the equation (21) is extracted. According to the equation (21) and the equation (15) which is a state equation of the perfect gas, the equation (25) is extracted as follows.

$$\begin{matrix}G = \frac{aw}{v} = \frac{{a}_{1} {w}_{1}}{{v}_{1}} = \frac{{a}_{2} {w}_{2}}{{v}_{2}} = \frac{{a}_{t} {w}_{t}}{{v}_{t}} & ( 21 ) \\ pv = RT {v}_{t} = \frac{{RT}_{t}}{{p}_{t}} & ( 15 ) \\ G = \frac{{a}_{t} {w}_{t} {p}_{t}}{{RT}_{t}} & ( 25 )\end{matrix}$$

The signs shown in the equation (25) are obtained by the following equations.

$$\begin{matrix}{a}_{t} = {π ( \frac{d}{2} )}^{2} \cdot {m}^{2} . \\ {w}_{t} = c = \sqrt{g κ R {T}_{t}} \cdot m \text{/} sec . \\ {p}_{t} = {p}_{c} = {{p}_{1} ( \frac{2}{κ + 1} )}^{\frac{κ}{κ - 1}} \cdot Pa . \\ {T}_{t} = {T}_{c} = {{T}_{1} ( \frac{{p}_{c}}{{p}_{1}} )}^{\frac{κ - 1}{κ}} \cdot K . \end{matrix}$$

The flow speed wt in the throat is determined by assuming that the flow speed is equal to a “sonic speed c” at which a slight disturbance in the fluid propagates as an isentropic flow. The equation (27) is obtained by putting the equations (15), (16) into the equation (26).

$$\begin{matrix}c = \sqrt{\frac{ⅆ p}{ⅆ ρ}} & ( 26 ) \\ pv = RT & ( 15 ) \\ {pv}^{κ} = const & ( 16 ) \\ c = \sqrt{\frac{κ p}{ρ}} = \sqrt{g κ p v} = \sqrt{g κ R T} & ( 27 )\end{matrix}$$

And, p_{c} is the gas pressure and T_{c} is the temperature under a sonic speed

In the present embodiment,
it is designated that .=1.4, R=286.85 J/kg·K, T₁=293 K, p₁=1.08 Mpa, p₂=0, 10 Mpa, L=0.024 m, and d=.3=0.003,
and therefore pₜ=p_{c}=0.57 kgf/cm², Tₜ=T_{c}=244 K, wₜ=313 m/sec, aₜ=7.1×10⁻⁶ m², and G=1.73 N/sec are obtained.

As described above, in the conditional equation (1), values other than the pressure p of the arbitrary position x which is to be a parameter are determined. Pressure p is obtained if the arbitrary position x in the conditional equation (2) is determined, the x is determined and the value a at the cross section area a of an arbitrary position from the conditional equation (1). A cross section shape of the injection nozzle is set to be round and the cross section diameter is determined based upon the cross section area a of the nozzle.

In order to specify a shape of the injection nozzle so that satisfying the above mentioned conditional equations (1) and (2), the injection nozzle is equally divided into 300 sections in the lengthwise direction, and a cross section area a of the injection nozzle is determined for each divided position to calculate the diameters (inner diameters).

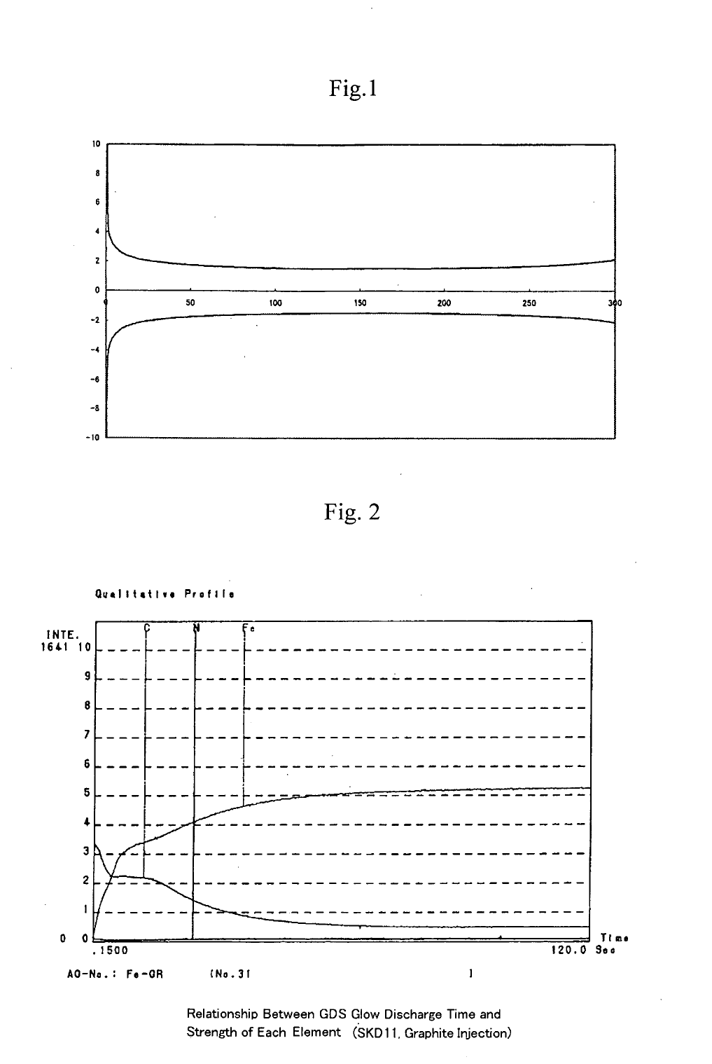

As a result, the cross section shape is obtained as shown in FIG. 1. In the present embodiment, substantially the middle position from the injection nozzle entrance to the injection nozzle exit i's the throat of the minimum inner diameter 0.3, and the inner diameter is expanded and widened from the throat toward the injection nozzle entrance and the injection nozzle exit.

Effects by Specifying Injection Nozzle Shape

An injection nozzle used for the conventional blast processing was a tapered nozzle where a cross section area of an aperture is gradually narrowed from the injection nozzle entrance to the exit, and the injection nozzle exit has the minimum cross section area.

Such tapered nozzle makes flow speed increase as the cross section of a gas flow path is getting narrower, and the gas flowing inside the nozzle has the maximum flow speed at the front end (nozzle exit) where the flow cross section area is the minimum.

However, expansion and acceleration of the gas flowing in the nozzle is possible in the range of a subsonic speed flow, and when a pressure difference in the gas between at the nozzle entrance and at the exit increases more than a predetermined value and reaches a critical state, even if the pressure difference becomes more than that, the gas flow speed does not change (choke). Therefore, it was not possible to increase the gas flow speed more than a critical flow speed, and even if the gas pressure in the nozzle entrance was increased, the injection speed of the gas could not be increased more than a predetermined value.

It is thought generally that the injection speed of an injection material by the tapered nozzle, although depending on material, specific weight, and shape thereof, had a limitation around 180 to 200 m/sec.

And in the tapered nozzle, the gas passing through an inside of the nozzle still has high pressure even in the nozzle exit. Therefore, the gas collides with the open air where the gas is released from the nozzle exit to the open air, possibly spreading the injection material injected together with the gas.

On the contrary, in the injection nozzle of the present invention the aperture formed in the nozzle has such a shape as to meet the conditional equations (1), (2), specifically the shape of the nozzle has a throat of the minimum cross section area from the nozzle entrance to the nozzle exit in the gas flow path, and a front portion of the throat is tapered, while a rear portion thereof is widened toward the outside.

According to this shape, the pressure of the gas which is still high at the throat can be decreased gradually in the widening rear portion after the throat, and the gas speed is further accelerated by the expansion accompanying the pressure decrease. Accordingly the gas flow speed when injected from the exit of the nozzle can be increased more than that of the conventional tapered nozzle.

Namely in the injection nozzle of the present invention, the flow speed of the gas is a subsonic flow speed, as is the case in the tapered nozzle, until the throat which has the minimum flow section area in the same manner, and thereafter the injection nozzle of the present invention can accelerate the flowing behavior of the gas to the supersonic flow speed from the throat towards the nozzle exit.

And the pressure of the gas passing through the injection nozzle can be sufficiently decreased in the widened portion after the throat, thereby to prevent the gas from colliding with the open air preserving a high pressure at the nozzle exit. This prevents the injection material injected together with the gas from spreading away, thereby to inject smoothly the injection material maintaining a high injection speed.

The acceleration from the subsonic flow speed to the supersonic flow speed as described above, is not carried out by simply disposing the throat in the flow path, but depends closely on a cross section area of the throat, cross section area of the nozzle entrance and exit, a length of the nozzle, a throat position in the entire nozzle length, and cross section shapes from the nozzle entrance to the throat, and from the throat to the nozzle exit and so on. Therefore, in the present invention, such a nozzle is employed that includes the flow path shape specified according to the conditional equations (1), (2) so that the pressure decrease of the gas flowing inside the nozzle is promoted, and the gas expands in a desired state due to the pressure decrease, to increase the flow speed of the gas preferably.

2. Blast Processing Method

Use of the flowing path according to the present invention achieved by the injection nozzle increases the injection speed of the injection material passing through the flow path, which enables various processes by injecting the injection material at high speeds. As one example of applications in such high speed blast processing method, in the present embodiment, a method of forming a coated layer on a work piece by injecting an injection material on the work piece, specifically a method of forming a lubricating layer by injecting a solid lubricant on a work piece surface will be explained.

Blast Processing Device

A blast processing device used in the present invention, is a direct-pressure type blast processing device which comprises, as a basic construction, a cabinet constituting a processing room, a hopper located under the cabinet to collect injection materials, a collection tank constituting a cyclone to separate the injected materials which are collected by the hopper and charged through a conduit into dust or the like and reusable injection materials, a dust collector to collect the dust separated by the cyclone, a compressor disposed in the cabinet to supply compressed air to the injection nozzle, and so on. These are arranged in a similar way as a conventional device but in order to increase an injection speed, the injection nozzle is to be the one to meet the conditional equations (1), (2).

Injection Material

As an injection material injected by the blast processing device equipped with an injection nozzle of the present invention, a solid lubricant providing a lubricating property on a work piece surface is used in the embodiment.

It is noted that such a case that a solid lubricant is used as the injection material as described above in the present embodiment will be explained, but as long as a desired effect is obtained by injecting the injection material at high speeds, an injection material for forming a coated layer other than the lubricant layer, an injection material for obtaining effects of cutting, grinding, shot peening or the like, and other injection materials for various purposes can be used. The application of the injection nozzle of the present invention is not limited to an injection of the solid lubricant.

Herein the solid lubricant includes graphite, hexagonal boron nitride, diamond powder, new carbon materials such as fullerene, carbon nanotubes, and carbon nanohorn and the like, oxide solid lubricants such as molybdenum disulfide, tungsten disulfide, tin bisulfide, mica, graphite fluoride, barium fluoride, calcium fluoride, gold, silver, lead, lead monoxide, barium chromate and the like. Besides, plastic materials such as Teflon (registered trademark) and the like, MCA (melamine cyanurate) and the like can be included and also a powder mixture thereof can be utilized as well. In the present embodiment, however, graphite powder is to be used as a solid lubricant.

The graphite powder is preferably powder of more than 90% carbon components and of 1 to 500 μm particle diameter, and as the kind thereof natural graphite such as scale-like graphite and earthy graphite, or artificial graphite can be named. In the present invention, any type of graphite can be used and in the present embodiment scale-like graphite called CPB made by Nippon Graphite Industries, Ltd. is used. The CPB is general graphite powder of excellent lubrication, molding, and conductivity, and the apparent density (bulk density) is 0.2 g/cm³, the particle diameter is in the range of 1 to 100 μm and the average particle diameter is approximately 19 μm.

Work Pieces to be Processed

As work pieces which are blast processed by the injected materials through the nozzle, there are various kinds of available materials such as metals, synthetic resin, ceramics, wood, leather, paper and so on, and it is possible to select properly depending on the object and details of the blast processes.

In the present embodiment, as work pieces for which the graphite powder of a solid lubricant is injected to form a lubricant, aluminum alloy, for example, and also metal such as steel which has higher hardness and higher melting point than the aluminum alloy can be used. Specifically, SKD11, SUJ2, SKS, and SUS440C as an iron group, and A5056 and A7075 and so on as aluminum group can be named.

The SKD11 is a kind of alloy tool steel and is used for cold mold processing of such as gauges, punching dies, and screw rolling dies. The SUJ2 is a kind of a high-carbon chrome bearing steel material used in ball and roller bearings or the like. The SKS is an alloy tool steel for cutting tools. The SUS440C is martensitic stainless steel and is used in nozzles and bearings or the like.

And the A5056 is an aluminum alloy widely used in various industrial products such as automobiles. The A7075 is named as extra super duralumin and has an excellent mechanical property such as strength or processability and is used for airplane frames and other structural materials.

In the present embodiment, these metals with lapping finished surface are used as work pieces.

Processing Conditions

The injection conditions in the case of injecting an injection material by a blast processing device of the present invention equipped with an injection nozzle to meet the conditional equations (1), (2), although depending on a kind of material, a particle diameter, and a particle shape of the injection material, may be set as an injection pressure of 0.01 to 5.0 MPa, for example, 0.1 to 2.0 MPa and an injection speed of 100 to 450 m/sec, for example, 180 to 300 m/sec.

Herein, the injection pressure means the pressure of gas at the injection nozzle entrance, and the injection speed means the speed of gas at the injection nozzle exit. The injection speed does not necessarily correspond to the speed of the injection material injected from the injection nozzle exit, and in fact the speed of the injection material is slightly slower than the injection speed. As one example, a speed of the injection material is thought to be approximately 0.6 to 0.8 the injection speed.

And as the other processing conditions, a distance (injection distance) between a work piece and an injection nozzle can be set 5 to 300 mm, for example, 20 to 200 mm and an injection time can be set 1 to 600 sec, for example, 20 to 90 sec, and can be properly changed according to processing details or processing conditions and so on. And a blast processing can be performed plural times of repetitions by a predetermined injection time.

In the present embodiment, a graphite powder is injected on a work piece and the processing conditions in this case are set preferably as the injection pressure of 1 to 1.5 MPa, the injection speed of 220 to 270 m/sec, the injection distance 30 to 50 mm, and the injection time of 20 to 90 sec.

It is noted that as a compressed gas passing through the injection nozzle and injected together with an injection material is preferably used nitride, air, or an inactive gas such as argon or helium from the safety point of view.

Blast Processing

When a blast processing is performed by a blast processing device equipped with an injection nozzle of the present invention, a speed of the gas injected from the injection nozzle becomes faster, thereby the speed of the injection is increased. Accordingly, kinetic energy of the injection material becomes larger than conventional one.

Accordingly, collision energy generated when the injection material collides with the work piece is increased more than the conventional case, and the effect obtained from one time collision of the injection material increases. As a result, in various blast processing methods such as cutting, grinding, and shot peening, the processing is carried out with high efficiency.

In a method of forming a coated layer by injecting an injection material on a work piece among the aforementioned blast processing methods, it is possible to form a coated layer having a strong adherence to a surface of the work piece. It is believed that the coated layer with strong adherence property, as described above, can be obtained due to physical and chemical effects. The components of the injection material are penetrated into inside of the work piece as a base material by injecting the injection material to generate a reaction phase of the base material components and the injection material component on the surface of a work piece. Further, the coated layer with strong adherence property can be obtained due to penetrating depth of the injection material components into the inside of the base material differs in each portion caused by composition inequality of the base materials and so on. Further, the coated layer made of the injection material components is solidly formed on the reaction phase of the base material components and the injection material components.

In the present embodiment, a lubricant layer made of graphite is formed on a work piece surface by an injection of the graphite. Although, in the conventional method, only molybdenum disulfide of high specific gravity can be used to produce collision energy necessary for coated layer formation, according to the present invention, since a large amount of collision energy can be produced by increasing the injection speed, even graphite with a smaller specific gravity as compared to the molybdenum disulfide can form a lubricant layer on a work piece suitably.

Comparative Example of Injection Speed

A comparison experiment with regard to injection speeds of the injection materials was carried out by using the blast processing device of the present invention equipped with a nozzle to meet the conditional equations (1), (2) (Embodiment 1) and the blast processing device equipped with the conventional tapered nozzle (Comparative Example 1).

It is noted that the blast processing devices include identical component parts with those in the conventional device other than the nozzle and uses, as an injection material, glass beads of #300, and the injection pressure is set as 1 MPa. The result is shown in the following table.

TABLE 1

| | Injection Speed |
|---|---|
| Embodiment 1 | 220 [m/sec] |
| Comparative Example 1 | 185 [m/sec] |

As understood from the above result, it becomes apparent to be able to increase the injection speed by a large margin by use of the nozzle according to the present invention.

Observation of Lubricant Layer State

A state of the lubricant layer formed on the work piece surface by the graphite injection is observed by the following various analysis methods.

(1) Glow Discharge Light-Emitting Spectroscopic Analysis (GDS Analysis)

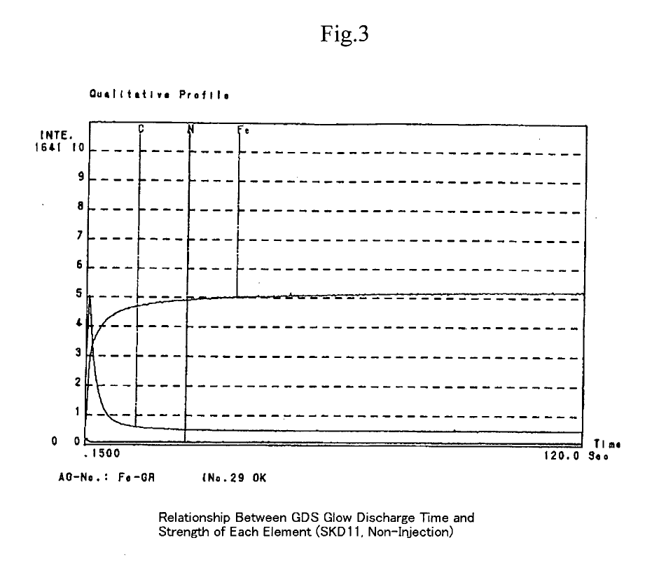

It was analyzed how much graphite exists in the depth direction by using GDLS-5017 made by Shimadzu Corporation. (direct current discharge type). SKD11 was used as a work piece and a case (Embodiment 2) where an injection pressure is 1 MPa, an injection speed is 250 m/sec, an injection distance is 50 mm, an injection time is 30 sec×2 and a case of non-injection (Comparative Example 2) were compared. The analysis was performed every given period of time through analyzing emitted light, sputtering by glow discharge in the Ar ion atmosphere. The analysis result of Embodiment 2 is shown in FIG. 2 and the analysis result of the Comparative Example 2 is shown in FIG. 3. The abscissa axis shows time and the ordinate axis shows a peak strength of elements in FIGS. 2 and 3.

In the analysis result (FIG. 3) of the Comparative Example 2, the carbon components C are extremely reduced from the work piece top surface, and in the Embodiment 2 (FIG. 2), many carbon components are detected from the top surface to a certain depth, namely approximately 1.2 μm in the depth. Accordingly it is understood that in the Embodiment 2, a lubricant layer into which carbon components are properly penetrated is formed.

(2) SEM-EDX Analysis

By using a combination of a field emission scanning electronic microscope (FE-SEM) and an energy dispersive spectroscopic analysis (EDX), the surface analysis is performed repeatedly in the identical portion after the Ar ion sputtering treatment, to analyze distribution of the existing elements in the portion. As a work piece are used SKD11, SUJ2, and A7075.

S-4100 Vacc: 15 kV made by Hitachi Co., Ltd. is used as a field emission scanning electronic microscope (FE-SEM), and EDS2000 system made by IXRF SYSTEM as an energy dispersive spectroscopic analysis (EDX), and a flat milling device E-3200 made by Hitachi Co., Ltd. as the Ar ion sputtering device.

The Ar ion sputtering condition is set as follows: Acceleration Voltage: 6 kV, Beam Current: 1 mA, Sample Oblique Angle: 60°, eccentric amount: 2.0 mm. Under the above condition the sputtering is performed once every 20 minutes. It is thought that the ion sputtering of approximately 0.5 μm depth is produced by one time.

The result of the surface analysis repeated for each sputtering treatment is shown by main components (Fe or Al) of each material and C relating to time elapsed. As for magnification of the microscope in observation, it was judged that a low magnification gave unclear distribution and in contrast a high magnification was likely influenced by existing deviations, therefore, the optimal magnification of 300 was adopted. AS for the points for the surface analysis, the cross markings were made in advance by a diamond pen to find the same points as close as possible and the analysis was performed in the vicinity of the center. In fact additive elements other than the main elements were also detected in each material, but were omitted in this analysis result because the purpose of the analysis is to confirm the existence of C.

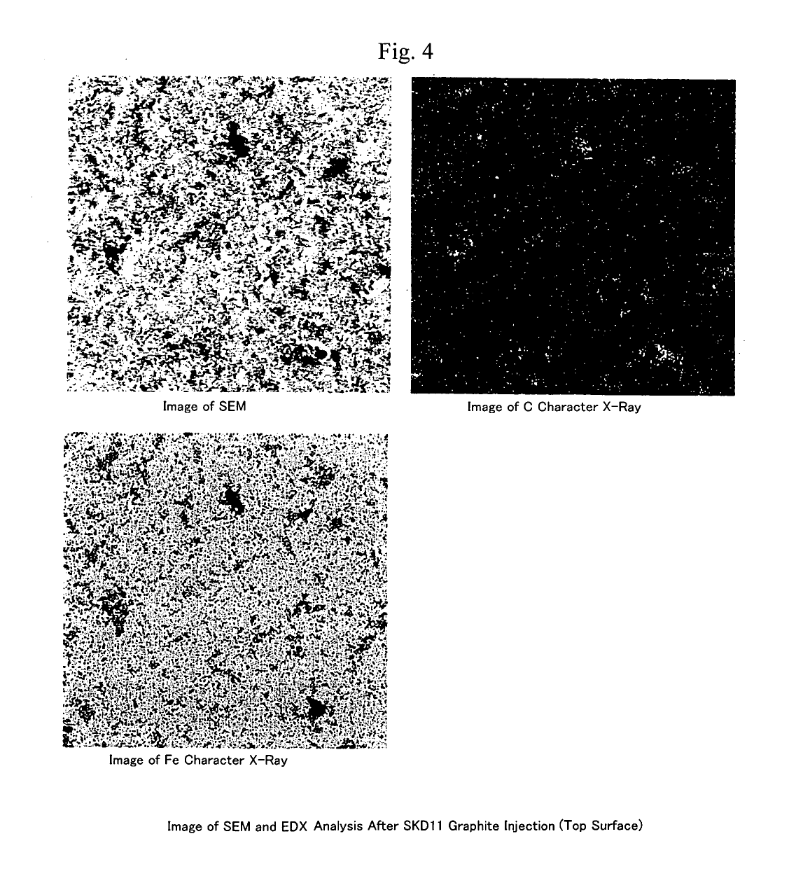

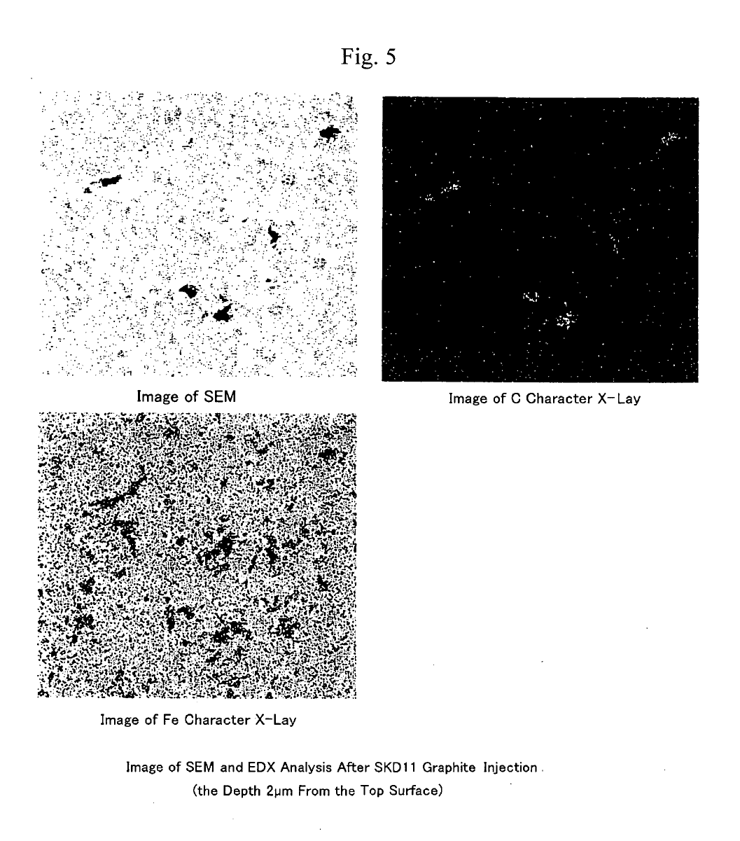

Herein for the case that SKD11 was used as a work piece and the graphite powder was injected on the work piece with an injection pressure of 1.5 MPa, an injection speed of 270 m/sec, and an injection time of 90 sec, the analysis result of the top surface is shown in FIG. 4 and the analysis result with the depth of 2.0 μm is shown in FIG. 5.

The result of the carbon distribution and the SEM image in the surface analysis shows that the carbon C is present in portions with a low contrast (dark portions) in the SEM image.

Consequently, it is confirmed that the carbon distribution in a desired state is formed on the work piece according to the method of the present invention.

Further, in the methods of the present invention, the carbon C was observed in deeper position in case of injection pressure 1.5 MPa, compared with the case of injection pressure 1.0 MPa. The case of the injection pressure of 1.0 MPa corresponds to the result of the GDS analysis and the carbon C exists in the depth direction of approximately 1 to 2 μm only. In contrast, in the sample with the injection pressure of 1.5 MPa, the carbon C exists in the depth of approximately 2.0 μm in the SKD11, approximately 7.0 μm in SUJ2, and approximately 3.5 μm in A7075.

Work pieces analyzed this time were hardened with standard hardening process for Fe and Al material, but only the top surface is thought to be tempered because the very top surface was exposed to high temperatures due to a high-speed injection of graphite, thereby it is assumed that difference condition was resulted in the depth direction between the work pieces.

(3) TEM Observation

A thin film sample for a section TEM close to the surface layer portion was produced using micro-sampling function by a focused ion beam device (FIB) and an existing state and a structural changing state of a graphite layer in a cross section of the surface layer portion of the work piece were observed by a transmission electron microscope (TEM). SUJ2, A7075, and SKD11 were used as work pieces, and the graphite powder was injected on the work piece with injection pressure of 1.5 MPa, injection speed of 250 m/sec, injection distance of 50 mm, and injection time of 90 sec. It is noted that Hitachi Co., Ltd.-made FB-2000A Vacc: 30 kV was used as a focused ion beam device (FIB) and Hitachi Co., Ltd.-made HF-2000 Vacc: 200 kV was used as a transmission electron microscope (TEM), and NORAN-made Voyage system was used as a TEM-EDX device.

In the FIB device, an arbitrary portion of a work piece was picked up by a manual probe in the FIB and fixed on a copper mesh to enable a thin film processing. After it is confirmed where the C exists on the surface of the work piece by SEM, the confirmed portion is used as a TEM-thin film sample.

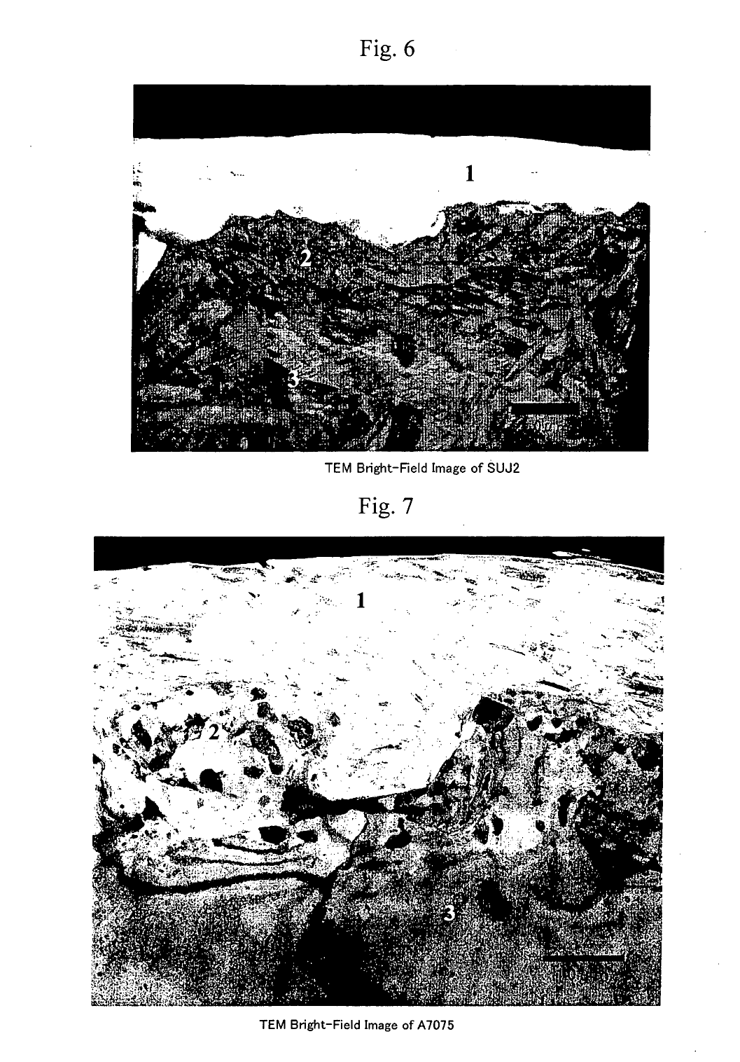

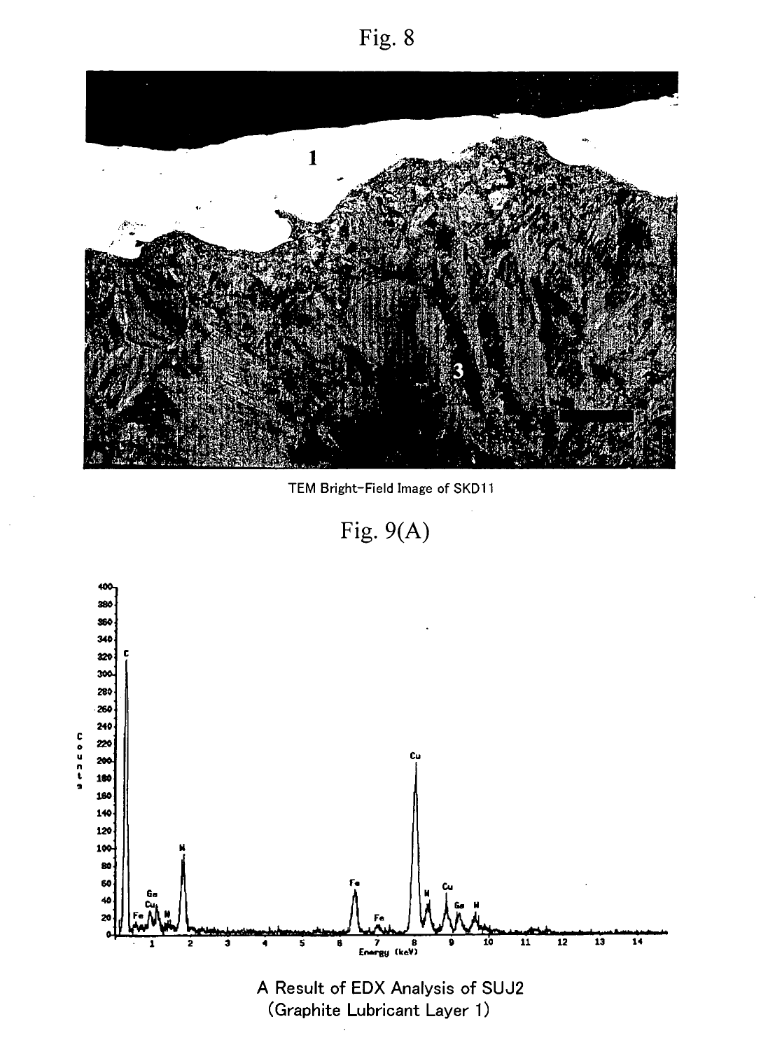

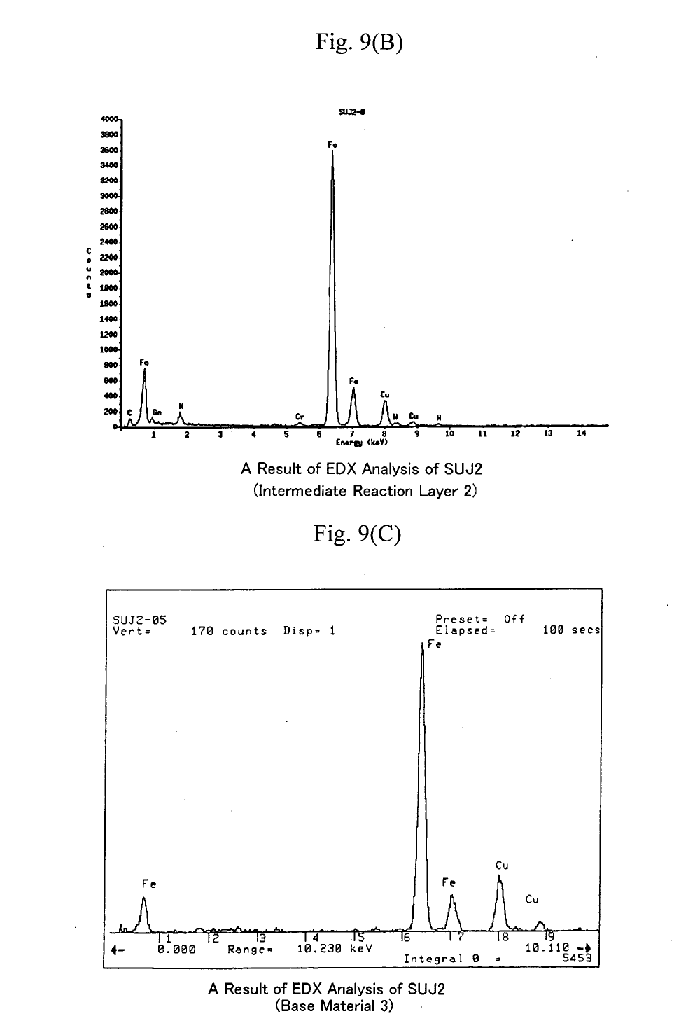

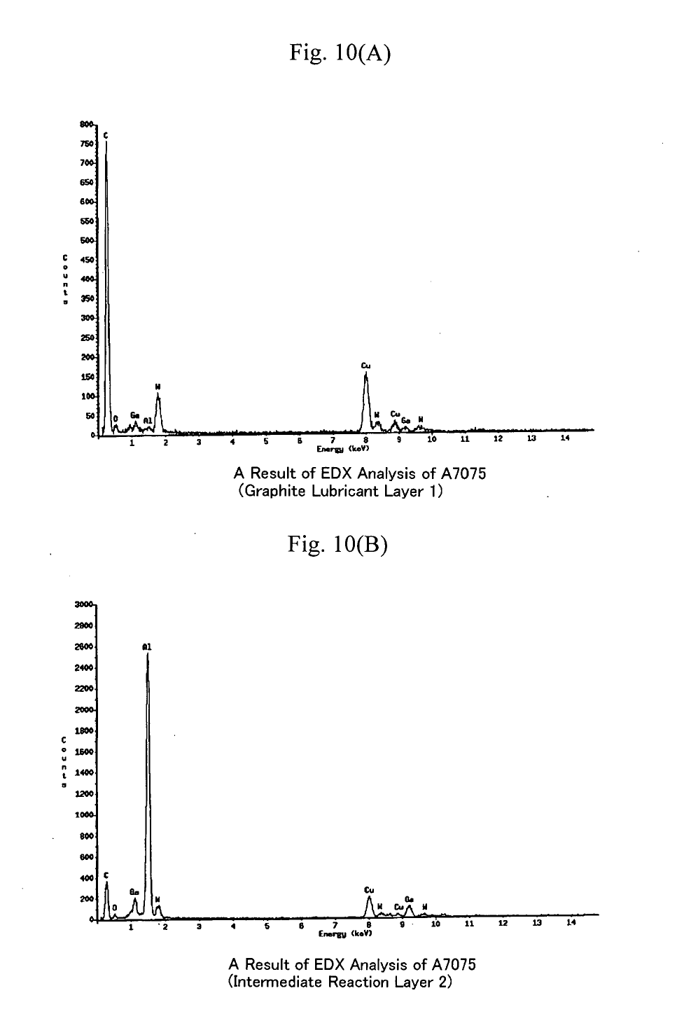

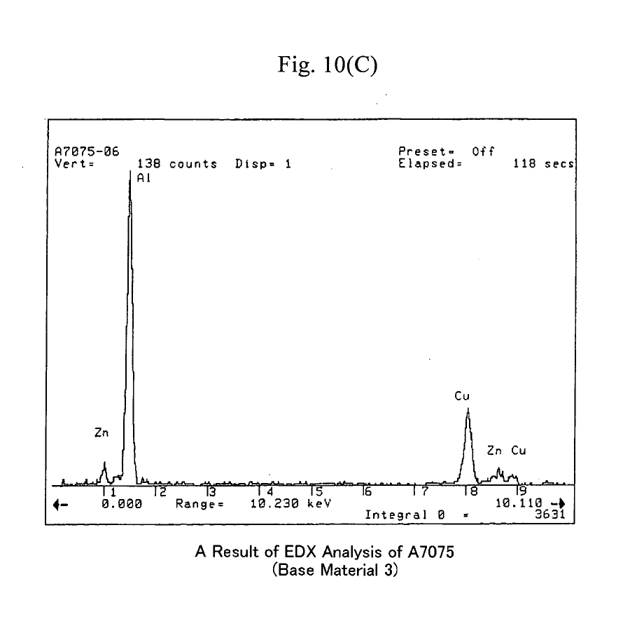

Observed result of the TEM-thin film sample proved the followings. FIG. 6 shows a TEM observation photo of SUJ2 on which the graphite lubricant layer is formed by the method of the present invention, FIG. 7 shows TEM-observation photo of A7075, and FIG. 8 shows TEM observation photo of SKD1. TEM-EDX analysis result of the SUJ2 is shown in FIGS. 9A to 9C and TEM-EDX analysis result of the A7075 is shown in FIGS. 10A to 10C.

From the TEM observation photos in FIG. 6 to FIG. 8, three-layer structure of a graphite lubricant layer 1, a reaction layer (intermediate layer) 2, and a base material 3 was confirmed. With regard to SUJ2 material and A7075 material, a boundary between the graphite layer 1 and the reaction layer 2 was observed at high magnifications, it was found that the reaction layer 2 was formed of a very small and fine crystal particle. A thickness ratio of the graphite layer 1 to the reaction layer 2 was approximately 2 to 3:1.

An original shape of graphite as an injection material was a phosphor-piece shape of 1 to 100 μm (averaging particle diameter: approximately 20 μm) and the shape of the graphite after shot changed into a flat shape squeezed in the thickness direction (depth direction). The shape of graphite particles was substantially equal and graphite particles were overlapped from the surface to the depth of approximately 1 to 2 μm.

Inside of the layer 1, observed as a single-like layer of graphite, was analyzed by TEM-EDX, and some particles of base material main component were detected (FIG. 9A, FIG. 10A). The reason for it is estimated that, as seen from the cross section shape, the base material is chipped off in shot process and some particles that float up or separate from the surface together with the graphite are pressed by further injected graphite and are adhered again.

(4) FE-AES Analysis

A depth direction analysis of the work piece was performed by using a field emission Auger electron spectroscopy analysis device of Model 1680 made by ULVAC-PHI. INC. SKD11 was used as a work piece and the graphite powder was injected with an injection pressure of 1.5 MPa, an injection speed of 270 m/sec, an injection distance of 50 mm, and an injection time of 90 sec.

The depth direction analysis is a method of monitoring time-series change of concerned elements while radiating Ar⁺ ion beam on a sample surface, and sputtering removing. The acceleration voltage was 5 kV, absorption current was 5 nA, and measuring area was approximately 1 μm². The conversion into the depth was performed in such a way that depth direction analysis of a SiO2 film having a known film thickness was carried out to calculate a sputtering rate from an ion beam radiation time. A value of the sputtering rate was 44.2 nm/min.

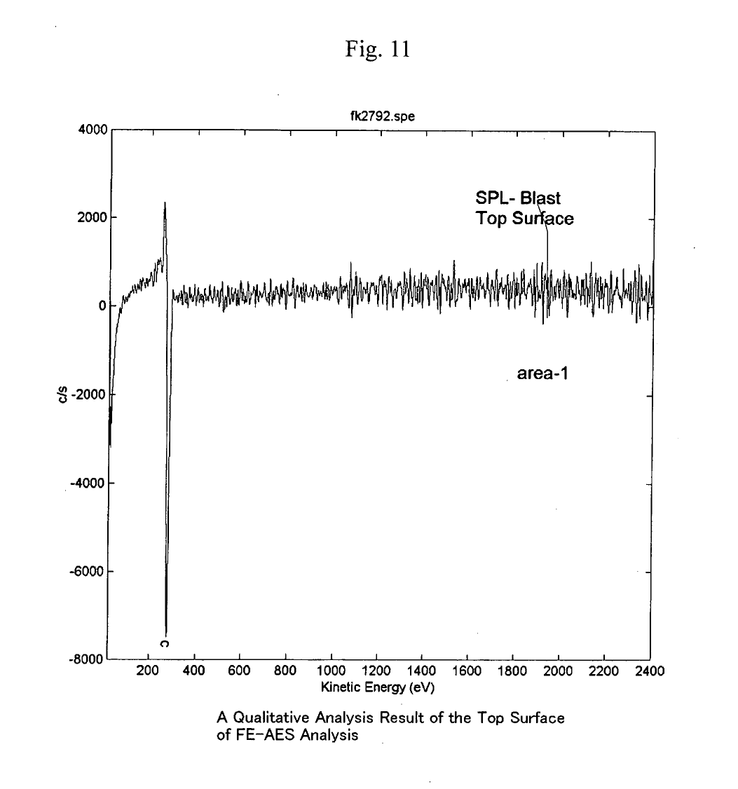

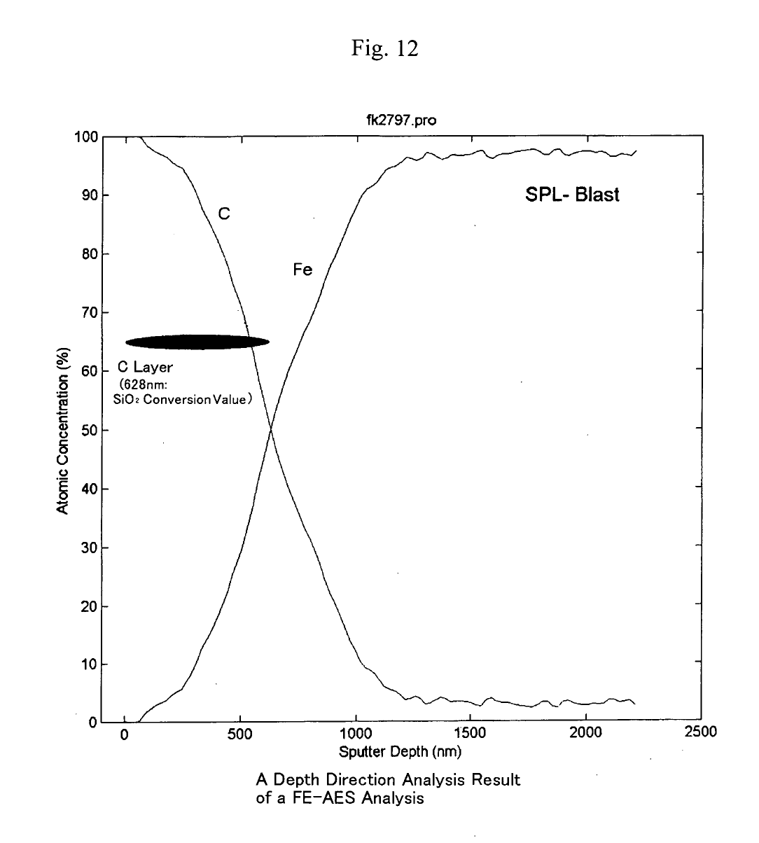

A qualitative analysis result of the top surface measured in this way is shown in FIG. 11 and the depth direction analysis result is shown in FIG. 12. By the way, only carbon components C were to be detected from the top surface. It was understood that the graphite layer was 628 nm deep from the depth direction analysis result (SiO₂ conversion value).

Tribology Performance Evaluation

A tribology performance evaluation such as friction property, wear property, or the like of a lubricant layer formed by the method of the present invention was performed.

(1) Friction Experiment

A friction experiment of a sample was performed by a ball-on disc type friction experiment device.

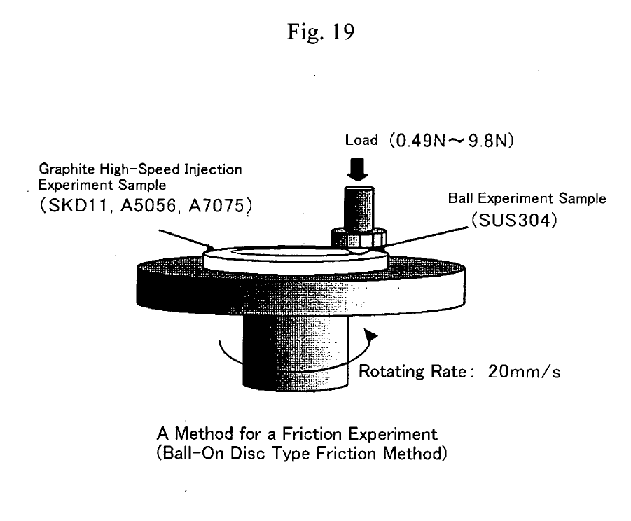

The ball-on disc type friction experiment device, as shown in FIG. 19, secures a sample together with a disc holder on a stage, rotates the stage to produce friction between the sample and a ball experiment piece as an opponent, and measures the friction generated between the sample and a ball experiment piece. The ball experiment piece is secured to an arm with the ball holder, and a load is applied by putting a weight right above the ball experiment piece. The available measurement range is within a friction force 5 kgf which is a rated capacity of a friction detector.

The ball experiment piece as the opponent was SUS304 ball of 3/16 inches.

As samples, an alloy tool steel (SDK11) and two kinds of aluminum alloys (A5056 & etc.) were processed to form like a disc having a diameter of 20 mm and a thickness of 5 mm and then the surface thereof was mirror-finished, thus work pieces were prepared. The graphite powder having an average particle diameter of 6 μm was injected directly on work pieces with highly pressurized air or nitrogen with an injection pressure of 1 MPa, an injection speed of 250 m/sec, an injection time of 32 sec, and an injection distance of 25 mm, to form a lubricant layer, which was regarded to be embodiments of the present invention (SDK11: Embodiment 3, A5056: Embodiment 4). The work piece without graphite injection was regarded as a Comparative Example (SDK11: Comparative Example: 3, A5056: Embodiment 4).

The samples of the embodiments and the Comparative Example, and the ball experiment piece were cleaned by an ultrasonic cleaning for 10 minutes by using cleaning liquid prepared by mixing petroleum benzine with acetone at a ratio of 1:1 before the friction experiment. The experiment was carried out at room temperature in the atmosphere. The friction surfaces of the sample and the ball experiment pieces were observed before and after the experiment by an optical microscope and photos were taken. The observation and the photo taking were performed before and after wiping the adhered wear powder. And a surface shape of a friction surface of the sample was measured by a surface roughness detector.

In the Embodiment 3 and the Comparative Example 3, a slip rate was 20 mm/sec and in the Comparative Example 3, the load was 0.49 N, and in the Embodiment 3, the load was 4.9 N where the friction experiment was performed.

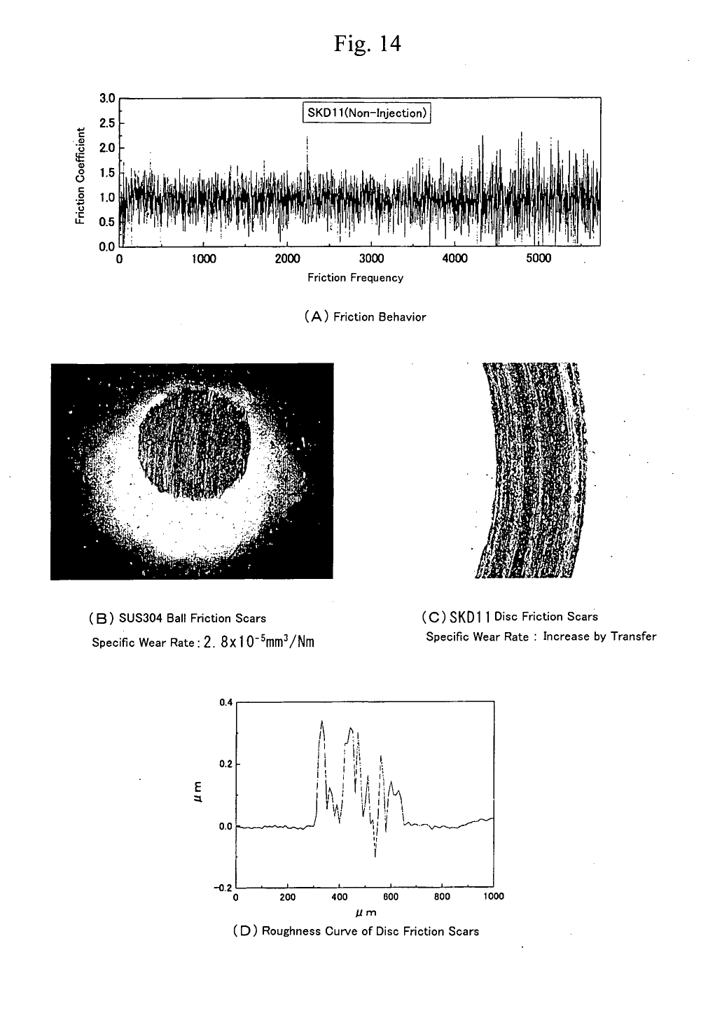

FIG. 14A shows a friction behavior view of the Comparative Example 3, FIGS. 14B and C show an optical microscopic photo of friction scars of the Comparative Example 3, and FIG. 14D shows a roughness curve of disc friction scars of the Comparative Example 3. The friction behavior fluctuated from the beginning of the friction and showed a friction coefficient of approximately 1.0. It was observed that from the state of the friction scars the ball was worn and the disc, as seen from the roughness curve, was swollen than the original surface due to transferring from the ball.

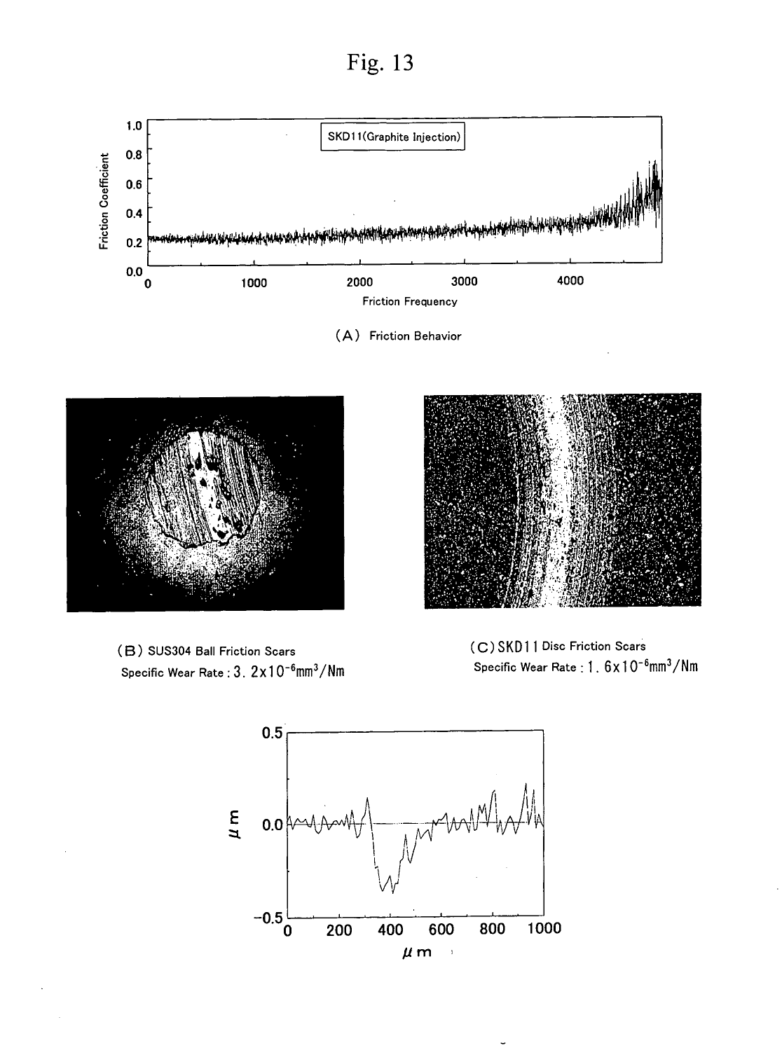

On the other hand, as seen from FIGS. 13A to 13D, the friction coefficient of the Embodiment 3 where the graphite was injected was maintained as the friction coefficient value of approximately 0.2 under the load of 4.9N to the friction frequency of approximately 3000 times.

When a sample was used in such a way that an injection distance of the graphite was 50 mm, other injection conditions were the same as in the Embodiment 3, the friction coefficient value of approximately 0.15 was maintained up to the friction frequency of approximately 30,000 times.

Next, with regard to the Embodiment 4 and the Comparative Example 4, a slip rate was set as 20 mm/sec and in the Comparative Example 4 a load was set as 0.49 N, and in the Embodiment 4 a load was set as 1.96 N. Under these conditions the friction experiment was performed.

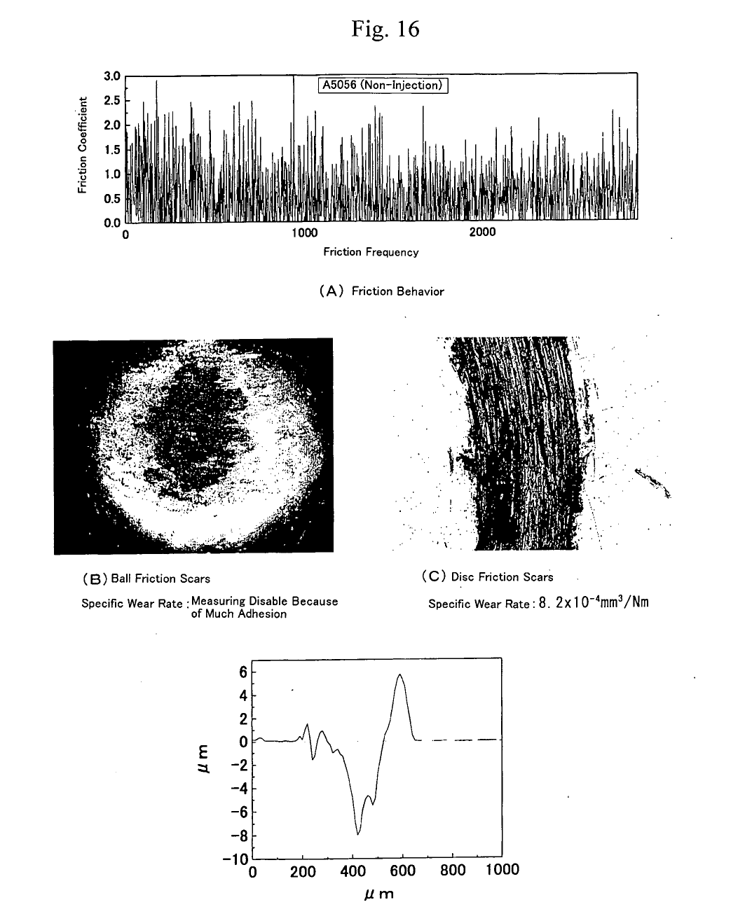

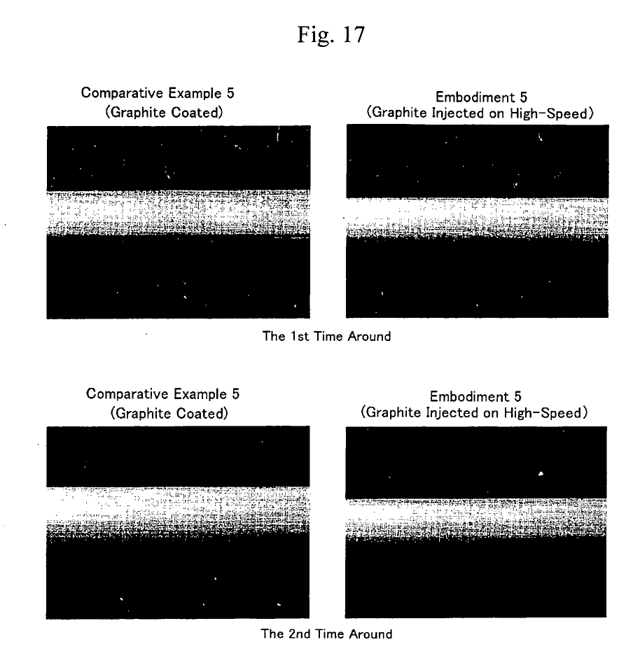

In the Comparative Example 4, the friction coefficient showed equal to or more than 0.5 from the beginning of the friction and the friction fluctuation and the disc wear were large, and further, much adhesion on the ball from the disc existed. Accordingly the wear amount could not be measured (FIG. 16A to 16D).

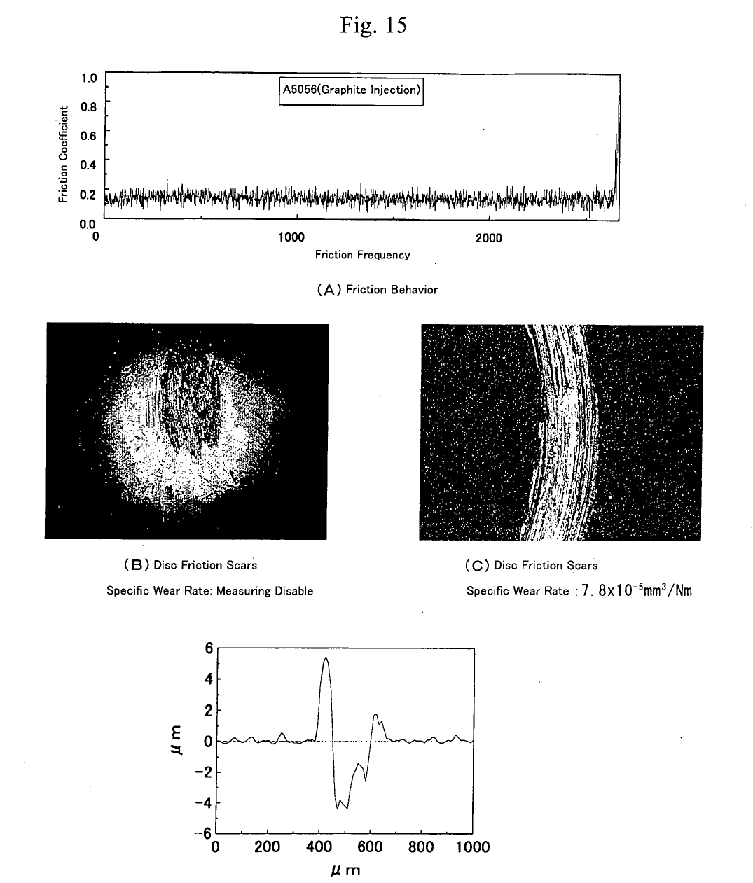

In contrast, the Embodiment 4 maintains a friction coefficient value equal to or less than 0.2 until the number of frictions exceeds 2000 times under a load of 1.96 N and the roughness curve of the disc friction scars shows clearly that the roughness is smaller than that of the Comparative Example 4 (FIGS. 15A to 15D).

In addition, in the Embodiment 4, the wear amount of the ball could not be measured similarly to the case of Comparative Example 4. However, since the aluminum alloy is softer than SKD11 and has a lower melting point, adhesion due to plastic deformation in the portion of metal contact is likely to occur and a lifecycle of graphite is short, so the wear amount is thought to increase. Further, the difference in the hardness increases the friction coefficient of A5056 over SKD11 and the friction fluctuation increases.

Extrusion Processing Experiment

An extrusion processing is such a processing method that billets inserted into a container are pressurized to flow out materials through a dice having an aperture shape provided at the container end, to produce various shapes.

In the present experiment, a container into which an extrusion-billet was inserted was heated to 773 k and thereafter, the billet was extruded under the condition of an extrusion speed of 50 mm/min by a hydraulic press with 200 ton capacity thereof to produce a rod-like molded piece. Surface accuracy of the molded piece was investigated. Material of extrusion experiment piece was Al, which was processed to be a billet of 0.38×30 mm for use. An extrusion dice of an extrusion ratio of 18 and an opening angle of 90° was prepared for a hot extrusion billet.

The Embodiment 5 was a case that graphite was injected on the extrusion dice with an injection pressure of 1.2 MPa, an injection speed of 260 m/sec, and an injection time of 90 to 120 sec, and the Comparative Example 5 was a case that graphite lubricant was coated on the dice. Extrusion molded products were manufactured in hot extrusion process using above arrangements. Further, hot extrusion experiments were sequentially carried out two times for each embodiment and comparison experiment to investigate a lifecycle of the lubricant layer.

As a result of surface observation of extrusion molded pieces, as shown in FIG. 17, linear defects due to seizing was observed on the surface of the extrusion molded pieces in both the Embodiment 5 and the Comparative Example 5, but it was proved that the number of the surface defects in the Embodiment 5 was extremely smaller as compared to that in the Comparative Example 5. The same result was observed in the second extrusion.

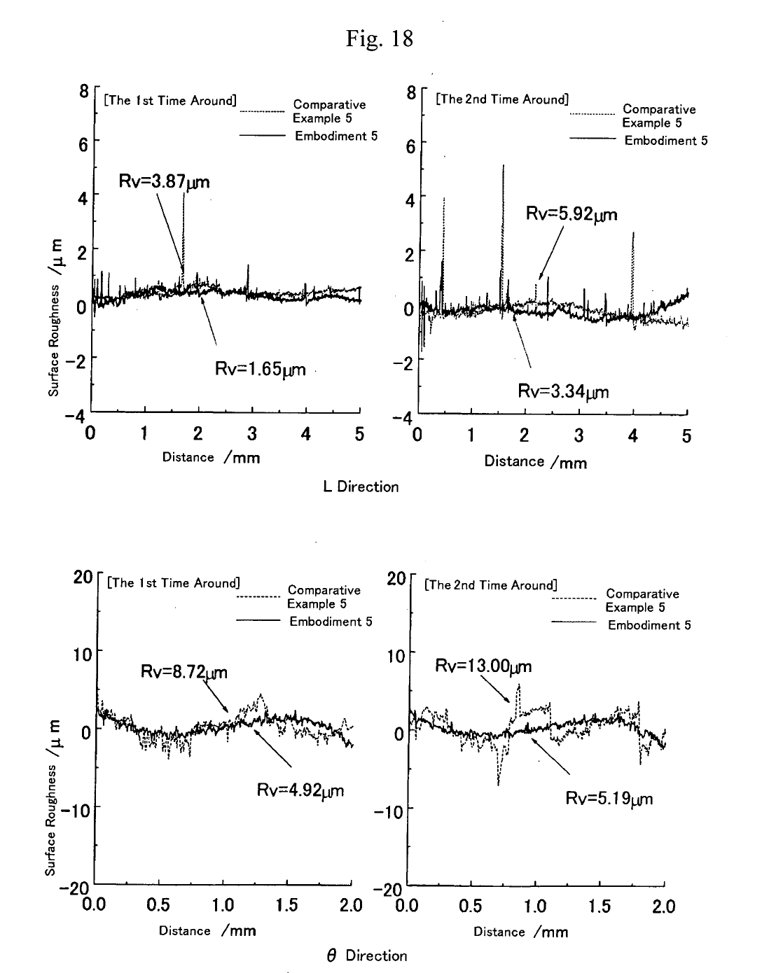

The surface roughness measurement result in the axis (L) direction and in the circumferential (.) direction of the extrusion molded pieces are shown in FIG. 18. The result shows that the surface roughness both in the L direction and in the direction of the Embodiment 5 is lower than that in the Comparative Example 5 is obtained (Embodiment: Ry 1.65 μm for the first, Ry 3.34 μm for the second, Comparative Example: Ry 3.87 μm for the first, Ry 5.92 μm for the second).

As described above, when a lubricant layer is formed in a mold according to the method of the present invention, an excellent seizing-restraining effect is achieved in a hot extrusion process that is accompanied with a remarkable material flow at high temperature. Accordingly completed extrusion molded pieces have no stain adhesion and besides due to the seizing-restraining effect, a quality and a size accuracy of an extrusion molded pieces can be improved and in particular the effect to the Al material can be excellent.

### Industrial Applicability

An injection nozzle of the present invention can be applied to an entire blast processing field, specifically to various blast processing such as coated layer formation, shot peening, grinding, cutting processing or the like which may obtain desired effects by injecting an injection materials. In particular, the injection nozzle of the present invention can be properly applied to a field in which an injection material with a small specific gravity or with a small particle diameter such as fine powder is used, and specifically to a field of a lubricant layer formation described in the embodiments.

In addition, a formation method of a lubricant lay.er of the present invention can be widely used as a method of forming a strong lubricant layer in place of a conventional coating of a lubricant and a chemical method such as sputtering, and the application area thereof includes such fields as piston of engines, and machine tools, instruments, apparatus or the like equipped with a sliding portion such as various bearings and shafts and so on, furthermore an automotive industry and various manufacturing industries of machinery.

Thus, the broadest claims that follow are not directed to a machine that is configuration a specific way. Instead, said broadest claims are intended to protect the heart or essence of this breakthrough invention. This invention is clearly new and useful. Moreover, it was not obvious to those of ordinary skill in the art at the time it was made, in view of the prior art when considered as a whole.

Moreover, in view of the revolutionary nature of this invention, it is clearly a pioneering invention. As such, the claims that follow are entitled to very broad interpretation as to protect the heart of this invention, as a matter of law.

It will thus be seen that the objects set forth above, and those made apparent from the foregoing description, are efficiently attained. Also, since certain changes may be made in the above construction without departing from the scope of the invention, it is intended that all matters contained in the foregoing description or shown in the accompanying drawings shall be interpreted as illustrative and not in a limiting sense.

It is also to be understood that the following claims are intended to cover all of the generic and specific features of the invention herein described, and all statements of the scope of the invention which, as a matter of language, might be said to fall therebetween. Now that the invention has been described;

1. An injection nozzle for a direct pressure type blast processing device which injects a mixture of an injection material and compressed gas, wherein an aperture formed in an axial direction of said injection nozzle meets the following conditional equations (1) and (2) at a cross section orthogonal to the axial direction at an arbitrary distance x away from an entrance of the injection nozzle,
$$\begin{matrix}a = {\frac{G}{{p}_{1}} [ \frac{2 g κ}{κ - 1} \frac{1}{R {T}_{1}} \{ {( \frac{p}{{p}_{1}} )}^{\frac{2}{κ}} - {( \frac{p}{{p}_{1}} )}^{\frac{κ + 1}{κ}} \} ]}^{- \frac{1}{2}} & ( 1 ) \\ \frac{p}{{p}_{1}} = 1 - ( 1 - \frac{{p}_{2}}{{p}_{1}} ) ( \frac{x}{L} ) , & ( 2 )\end{matrix}$$
wherein
a: cross section area orthogonal to the axial direction at an arbitrary distance x away from the entrance of the injection nozzle
G: weight flow amount of gas
g: acceleration of gravity
.: specific heat ratio of gas
R: gas constant
T₁: temperature of gas at the entrance of the injection nozzle
p: pressure of gas at an arbitrary distance x away from the entrance of the injection nozzle
p₁: pressure of gas at the entrance of the injection nozzle
P2: pressure of gas at the exit of the injection nozzle
L: length of the injection nozzle

2. The direct pressure type blast processing device, wherein said injection nozzle as set forth in claim 1 is equipped.

3. A blast processing method comprising the steps of:
passing an injection material and compressed gas through a path to accelerate a mixture of said injection material and said compressed gas by said path which meets the following conditional equations (1) and (2) and
thereafter injecting said mixture on a surface of a work piece.
$$\begin{matrix}a = {\frac{G}{{p}_{1}} [ \frac{2 g κ}{κ - 1} \frac{1}{R {T}_{1}} \{ {( \frac{p}{{p}_{1}} )}^{\frac{2}{κ}} - {( \frac{p}{{p}_{1}} )}^{\frac{κ + 1}{κ}} \} ]}^{- \frac{1}{2}} , and & ( 1 ) \\ \frac{p}{{p}_{1}} = 1 - ( 1 - \frac{{p}_{2}}{{p}_{1}} ) ( \frac{x}{L} ) , & ( 2 )\end{matrix}$$
wherein
a: section area orthogonal to the axial direction in an arbitrary distance x away from the entrance of the path
G: weight flow amount of gas
g: acceleration of gravity
.: specific heat ratio of gas
R: gas constant
T₁: temperature of gas at the entrance of the path
p: pressure of gas in an arbitrary distance x away from the entrance of the path
p₁: pressure of gas at the entrance of the path
p₂: pressure of gas at the exit of the path
L: length of the path

4. A method for forming a lubricating layer, wherein in the method as set forth in claim 3, said injection material is solid lubricant which is accelerated through said path and is injected on the surface of the work piece to form a lubricating layer thereon with the solid lubricant.

5. A method for forming a lubricating layer, comprising the steps of:
using a graphite powder comprising equal to or more than 90% of carbon components having a particle diameter is 1 to 100 μm as a solid lubricant; and
injecting the graphite powder with an injection pressure of 1.0 Mpa to 1.5 MPa and an injection speed of 220 to 270 m/sec on said work piece, to form the lubricating layer made of graphite on said work piece.

6. A sliding product, wherein the lubricating layer is formed according to the method as set forth in claim 4 or 5.
